(19) United States
(12) Patent Application Publication
(10) Pub. No.: US 2023/0144563 A1
(43) Pub. Date: May 11, 2023

(54) METHOD FOR OPERANDO TESTING OF THE FORMATION OF THE SOLID ELECTROLYTE INTERFACE LAYER OF A BATTERY CELL VIA TEMPERATURE AND/OR PRESSURE SENSING

(71) Applicants: FAURECIA SYSTEMES D'ECHAPPEMENT, NANTERRE (FR); COLLEGE DE FRANCE, PARIS (FR)

(72) Inventors: Selma BEN SAAD, MONTBÉLIARD (FR); Jean-Marie TARASCON, PARIS (FR); Laura ALBERO BLANQUER, PARIS (FR); Jiaqiang HUANG, PARIS (FR)

(21) Appl. No.: 17/916,143

(22) PCT Filed: Apr. 3, 2020
(86) PCT No.: PCT/IB2020/000299

§ 371 Date: Sep. 30, 2022

(51) Int. Cl. H01M 10/42; G01K 11/3206; G01L 11/02

(52) U.S. Cl. CPC H01M 10/4285; G01K 11/3206; G01L 11/025

(57) ABSTRACT

The invention relates to a method for in-life testing of the formation of the solid electrolyte interface layer of a battery cell, comprising the following steps:
sensing the temperature within the battery cell,
recording a first set of temperature (T) and/or pressure data related to the temperature variation (ΔT) and/or pressure variation within the battery cell over a first charge of the battery cell, and
determining a positive or negative datum relating to the formation of solid electrolyte interface layer of the battery cell according to said first set of temperature and/or pressure data

### CROSS-REFERENCE TO RELATED APPLICATIONS

This application is the US national phase of PCT/IB2020/000299 in, which was filed on Apr. 3, 2020.

### FIELD OF THE DISCLOSURE

The disclosure relates to the field of batteries, and more particularly the field of testing the formation of the solid electrolyte interface layer (SEI) for batteries, which include but not limit to Lithium ion (Li-ion) and Sodium-ion (Na-ion) batteries.

### BACKGROUND

With batteries being increasingly used in both the transport and power sectors, there exists a need to increase their reliability and performance

It is well-known in the field of batteries that the formation of the SEI layer, a passivating film that results from the self-limited partial catalytic decomposition of the electrolyte at the electrode surfaces for potentials beyond its range of thermodynamic stability, is one of the major factors influencing the performance of the battery cell over time. Indeed, even though the formation of the SEI Layer is essential for the battery cell to function, if it occurs in excess, it may lead to undesirable lithium ions consumption, significant increases in impedance, and the reduction of the active electrode area, leading to a decrease of the performance of the battery cell over time. As such, the formation of SEI, which mainly controls the cell lifetime is a critical and expensive step in cell manufacturing, rendering the protocols as trade secrets among the manufacturers.

However, at present it is not possible to test whether a SEI layer has formed correctly, that is, in a way that will not affect the long-term performance of the battery cell, at an early stage of the battery cell life. It is only after performing a long series of charge-discharge cycles, i.e. after actually witnessing the effects of a wrongly formed SEI layer on the battery cell performance, that it can be realized.

There is therefore a need to be able to determine, whether the SEI layer of a battery cell has formed correctly at an early stage of the battery cell life, which the disclosure attempts to provide.

### SUMMARY

The disclosure provides a method for operando testing of a solid electrolyte interface layer formation of a battery cell, comprising the following steps:
sensing a temperature within the battery cell;
recording a first set of temperature data related to a temperature variation within the battery cell over a first charge of the battery cell;
and—determining a positive or negative datum relating to a formation of the solid electrolyte interface layer formation according to said first set of temperature data.

The term “first charge” here relates to the very first time the battery cell is ever charged, i.e. the charge that is usually performed by the battery cell manufacturer before it is even commercialized. In addition, the term “over a first charge” is to be understood as over the time necessary to obtain a full charge of the battery cell.

The disclosure is based on the realization that, considering the SEI layer formation is caused by a surface decomposition of the electrolyte that is governed by electrochemical/chemical reactions, it can be monitored through the temperature variation associated to such reactions. In other words, by observing and analysing thermal events, such as a sharp rise in temperature variation, one can determine if a SEI layer has been correctly formed.

Hence, by recording temperature data related to the temperature variation within the battery cell over the first charge of the battery cell, during which the SEI layer is formed, and analysing it, a positive or negative datum relating the formation of the SEI layer of the battery cell can be given.

The disclosure therefore provides a way of determining, very early in the life of the battery cell, as early as after just one charge-discharge cycle, that the SEI layer has formed correctly or not. This is a tremendous improvement for battery cell manufacturers who can therefore test batteries in a much faster and much cheaper way.

Preferably, the sensing of the temperature is performed using an optical fiber Bragg grating sensor.

Indeed, owing to the temperature sensing using an optical fiber Bragg sensor, the temperature measurement inside the battery cell can be made in a precise, non-invasive and cheap way.

The small size of an optical fiber Bragg grating sensor (less than 200 μm in diameter) enables the non-destructive insertion of the temperature sensing element into the batteries. For instance, it can fit in the hollow part of batteries, such as 18650-format cylindrical cells. This makes the operando measurements of internal temperatures feasible.

Moreover, the optical fibers can be made of silicon with a polyamide coating, making them able to sustain the harsh chemical environment within the electrolyte of batteries. An optical fiber Bragg grating sensor also does not generate any electromagnetic interferences as it relies on optical signals. Finally, the temperature resolution of such a temperature sensor is 0.1° C.

According to a preferred embodiment of the disclosure, a negative performance datum is determined if a temperature variation above a predetermined threshold is detected to last over 50% of the total span of the first charge of the battery cell.

Indeed, the first criteria to detect a good or a bad formation of the SEI layer is the “width” of the peak of temperature variation over the first charge of the battery cell, i.e. if the temperature variation is detected over a large span of the charge of the battery cell. If the temperature variation is above a predetermined threshold over more than 50% of the total span of the first charge, for example more than 1° C., it implies the formation of an unstable SEI layer, as this means that parts of the deposits passes into solution, leaving fresh surface for further deposition to take place.

Preferably, the testing method also comprises a step of detecting a maximum temperature variation over the first charge of the battery cell, a positive formation datum being determined if said maximum temperature variation is detected before a predetermined threshold of the total span of the first charge of the battery cell, for example before 30% of the total span of the first charge for a Na-ion NVPF:C battery cell.

It has been observed that most of the reactions linked to the formation of the SEI layer occur at the beginning of the first charge, for example within the first 30% of the charge, and that temperature variations occurring afterwards are probably due to other electrochemical/chemical reactions. Thus, the presence of the maximum peak of temperature variation at the beginning of the first charge indicates an immediate trigger of the reactions responsible for SEI layer formation, and thus that they will not occur at a later stage, which would be mean that the SEI layer is unstable.

Advantageously, the datum relating to the formation of the solid electrolyte interface layer of the battery cell is also determined based on data regarding the chemical composition of the electrodes and/or the electrolyte, for example the amount of guest atoms inserted into the electrodes. For example, the predetermined threshold of the total span of the first charge of the battery cell mentioned above depends upon the type of chemistry and of the electrolyte additives.

This is to take advantage of the fact that temperature variations and their values vary depending on the chemical composition of the electrodes and/or the electrolyte.

Preferably, the testing method also comprises a step of recording a second set of temperature data relating to a temperature variation within the battery cell during a second charge of the battery cell, that is subsequent to a first discharge of the battery cell following said first charge of the battery cell, the positive or negative datum relating to the formation of the solid electrolyte interface layer of the battery cell being also determined according to the second set of temperature data.

Sensing and recording the temperature variation over the second charge of the battery cell, also helps determining the quality of the SEI layer formation. Indeed, the persistence or absence of temperature variations, and their level, after the first charge are an indication of the persistence or absence of electrochemical/chemical reactions and thus an indication of the stabilization, or lack thereof, of the SEI layer.

According to a particular embodiment of the disclosure, a positive performance datum is determined if the temperature variation over the whole span of the second charge is lower than a predetermined threshold, preferably sensibly equal to zero.

This would correspond to the ideal case where no more electrochemical/chemical reactions linked to the formation of the SEI layer are occurring during the whole second charge, indicating that it has rapidly stabilized and thus has formed correctly.

According to a particular embodiment of the disclosure, a positive performance datum is determined if the temperature variation recorded before a predetermined threshold, for example before 30% of the second charge is lower than a predetermined threshold.

As mentioned earlier, it has been observed that most of the reactions linked to the formation of the SEI layer occur at the beginning of a charge, for example within the first 30% of a charge and that temperature variations occurring afterwards are probably due to other electrochemical/chemical reactions. Thus, the absence of temperature variations at the beginning of second the charge indicates that the SEI layer has been fully formed during the first charge, i.e. is stable.

Preferably, the testing method also comprises the steps of:
a. sensing the pressure within the battery cell;
b. recording a first set of pressure data relating to the pressure variation within the battery cell over time during a first charge of the battery cell;
the datum relating to the formation of the solid electrolyte interface layer of the battery cell being also determined according to said first set of pressure data.

The electrochemical/chemical reactions associated with the decomposition of the electrolyte and thus the formation of the SEI layer are also associated to either the formation of gases, soluble products or both simultaneously. Hence, to decipher between these two scenarios, it is preferable to sense pressure besides temperature to improve further the SEI layer formation testing method.

According to a preferred embodiment of the disclosure, the testing method also comprises a step of detecting a maximum temperature variation over the first charge of the battery cell, a positive formation datum being determined if a maximum pressure variation over the first charge is detected before the percentage of the first charge at which the maximum temperature variation was recorded.

The testing method according to the disclosure here takes advantage of the information taken from both the temperature and pressure measurement. Indeed, the presence of both sharp temperature and pressure variations indicate a trigger of the reactions responsible for a stable SEI layer formation, which emit both heat and gases, within the first charge, and thus that they will not occur at a later stage, which would be that the SEI layer is unstable.

Preferably, the testing method also comprises a step of recording a second set of pressure data relating to a pressure variation within the battery cell during a second charge of the battery cell, that is subsequent to a first discharge of the battery cell following said first charge of the battery cell,
the positive or negative datum relating to the formation of the solid electrolyte interface (SEI) layer of the battery cell being also determined according to the second set of pressure data.

Sensing and recording the pressure variation over the second charge of the battery cell, also helps determining the quality of the SEI layer formation. Indeed, the persistence or absence of pressure variations, and their level, after the first charge are an indication of the persistence or absence of electrochemical/chemical reactions and thus an indication of the stabilization, or lack thereof, of the SEI layer.
c. According to a particular embodiment of the disclosure, a positive performance datum is determined if the pressure variation over the whole span of the second charge is lower than a predetermined threshold, preferably sensibly equal to zero.

This would correspond to the ideal case where no more electrochemical/chemical reactions linked to the formation of the SEI layer are occurring during the second charge, indicating that it has rapidly stabilized and thus has formed correctly.

The disclosure also relates to a testing device for testing the performance of a battery cell, comprising:
d. a temperature sensor, intended to be placed inside the battery cell, able to sense the temperature within the battery cell;
e. a memory for recording the temperatures sensed by the temperature sensor, and
f. a processor;
wherein said memory is able to record temperature data relating to temperature variation within the battery cell sensed by the temperature sensor during the first charge of the battery cell,
the processor being able to determine, according to the temperature data recorded by the memory, a positive or negative datum relating to the formation of the solid electrolyte interface layer of the battery cell.

According to a preferred embodiment of the disclosure, the testing device also comprises a pressure sensor, intended to be placed inside the battery cell, able to sense the pressure within the battery cell, wherein the memory is able to record a first set of pressure data relating to pressure variation within the battery cell sensed by the pressure sensor during the first charge of the battery cell, and
the datum relating to the formation of the solid electrolyte interface layer of the battery cell is also determined according to the first set of pressure data.

Preferably, the pressure sensor is an optical fiber Bragg grating sensor.

### BRIEF DESCRIPTION OF THE FIGURES

The disclosure will be better understood in view of the following description, referring to the annexed Figures in which:

FIG. 1 is a schematic view of a battery cell and a testing device according to the disclosure;

FIG. 2 is a schematic cut-out view in perspective of the battery cell of FIG. 1 in which an internal temperature sensor and an internal pressure sensor of the testing device according to the disclosure are inserted;

FIG. 3 is a series of graphs showing the voltage, temperature variation and pressure variation for a Na-ion Na3V2(PO4)2F3/hard carbon (NVPF/HC) cell with 1M NaPF₆ in DMC electrolyte over a state of charge of the battery cell, at an ambient temperature of 25° C.;

FIG. 4 is a series of graphs showing the voltage, temperature variation and pressure variation for a Na-ion Na3V2(PO4)2F3/hard carbon (NVPF/HC) cell with a 1M NaPF6 in EC-DMC (NP30) electrolyte over a state of charge of the battery cell, at an ambient temperature of 25° C.;

FIG. 5 is a series of graphs showing the voltage, temperature variation and pressure variation for a Na-ion Na3V2(PO4)2F3/hard carbon (NVPF/HC) cell with a 1M NaPF6 in EC-DMC (NP30) electrolyte over a state of charge of the battery cell, at an ambient temperature of 55° C.;

FIG. 6 is a series of graphs showing the voltage, temperature variation and pressure variation for a Na-ion Na3V2(PO4)2F3/hard carbon (NVPF/HC) cell with a customized electrolyte (Magic B) over a state of charge of the battery cell, at an ambient temperature of 55° C.; and

FIG. 7 is a series of graphs showing the voltage, temperature variation and pressure variation for a Li-ion /carbon (NMC111/C) cell with a 1M LiPF6 in EC-DMC (NP30) electrolyte over a state of charge of the battery cell, at an ambient temperature of 25° C.

### DETAILED DESCRIPTION

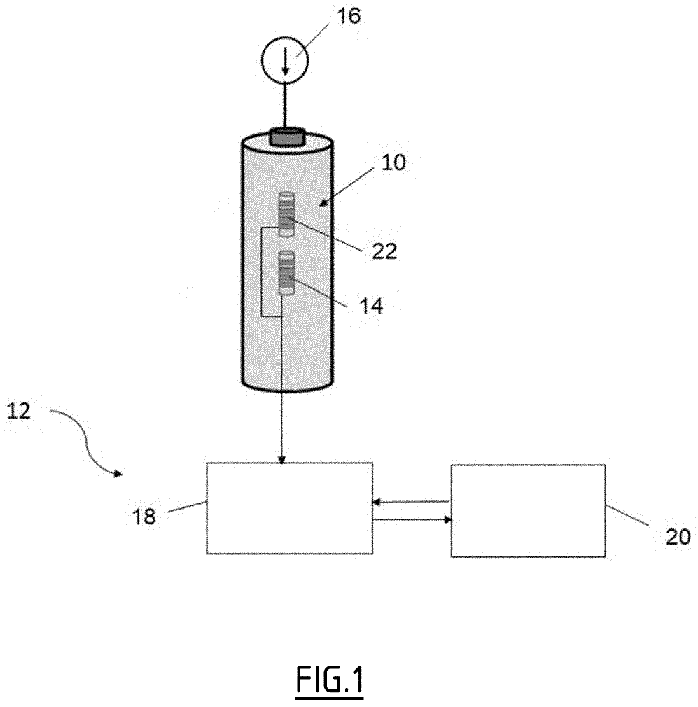

A battery cell 10 and a device for testing the solid electrolyte interface (SEI) of a battery cell 12, hereinafter named testing device 12, according to the disclosure are shown on FIG. 1.

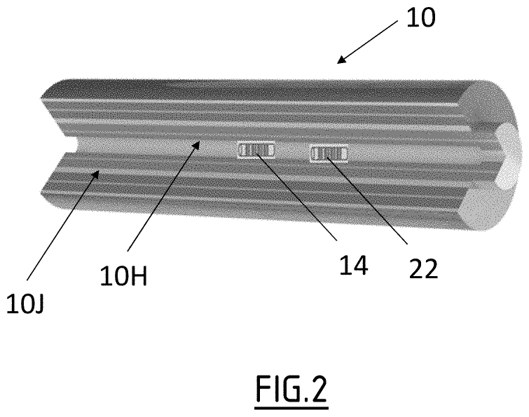

Battery cell 10, shown in FIG. 2, is for example a commercial Na-ion 18650 battery cell which comprises a circular cross-section and a central hollow section 10H within a jelly roll 10J. The jelly roll 10J itself comprises the positive electrode and negative electrode and a plurality of separators. Obviously, other formats of the battery cells such as pouch, prismatic, and coin cells can be used, as well as other electrode and electrolyte compositions as will be mentioned below.

Testing device 12 comprises an internal temperature sensor 14 placed inside the battery cell able to sense the internal temperature T within the battery cell. Internal temperature sensor 14 is preferably placed inside the hollow section 10H of the jelly roll. Internal temperature sensor 14 preferably is an optical Fiber Bragg grating sensor. It shall be noted that in other, less efficient embodiments of the disclosure, other types of sensors may be used to measure the internal temperature, for example a conventional thermocouple or even a thermometer.

Testing device 12 also comprises an electrical power source 16 for charging/discharging the battery cell 10. However, it should be noted that electrical power source 16 can be independent of testing device 12 and can be part of another device.

Testing device 12 also comprises a memory 18 recording temperature data relating to temperature variation within the battery cell 10 sensed by the temperature sensor 14 during the first charge of the battery cell.

Such a memory can be an external flash disk, a hard disk, a flash memory, etc. or any type of data recording device, or be part of the same device as the temperature sensors. For instance, when using an optical interrogator which obtains and converts the optical signal (variation of the wavelength due to the variation of temperature) from the optical fiber Bragg grating sensor into a temperature signal, said interrogator may also record the temperature signal.

Testing device 12 also comprises a processor 20 that determines, according to the temperature data recorded by the memory 18, a positive or negative datum relating to the performance of the battery cell 10, as will be explained below.

In this particular embodiment, testing device 12 also comprises an internal pressure sensor 22 placed inside the battery cell able to sense internal pressure T within the battery cell. Internal pressure sensor 22 is preferably placed inside the hollow section 10H of the jelly roll. Internal pressure sensor 22 preferably is an optical Fiber Bragg grating sensor. It shall be noted that in other, less efficient embodiments of the disclosure, other types of sensors may be used to measure the pressure, for example a conventional capacitive sensor, a conventional strain gage or a conventional piezoresistive strain gage. Pressure sensor 22 is placed as close as possible to temperature sensor 14 (pressure sensor 22 is placed apart from temperature sensor 14 on FIGS. 1 and 2 only for clarity purposes).

A method for operando testing of the solid electrolyte interface (SEI) layer formation of a battery cell according to the disclosure will now be described. This method is carried out using the testing device 12. According to a first step, the temperature T within the battery cell is sensed, here by the internal temperature sensor 14.

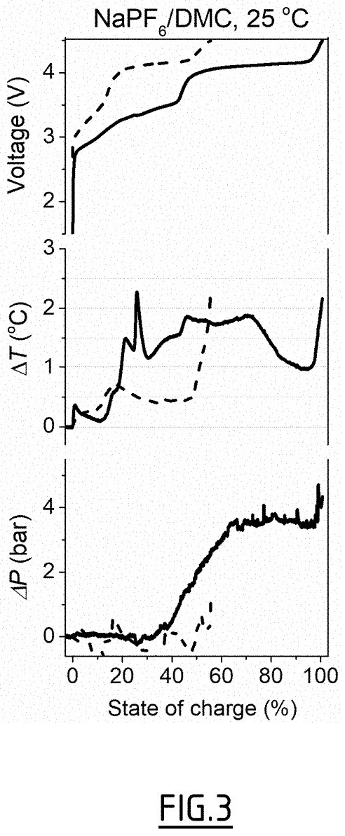

Then, a first set of temperature data related to the temperature variation ΔT within the battery cell 10 over a first charge of the battery cell is recorded. Preferably, the temperatures are recorded at regular intervals of time over the first charge of the battery cell, from 0% of charge to 100% of the first charge (in practice, the pre-set upper-limit voltage). Then, the temperature variation ΔT may be plotted against the percentage of charge (which is also a function of time), as shown on FIGS. 3 to 7. On all those Figures, the variation of temperature ΔT recorded over the first charge of the different battery cells 10 is shown in a plain line.

A first criterion for determining if the formation of the SEI layer is satisfactory is to consider the temperature variation over an important span of the charge, i.e. the “width” of the peak of temperature variation over the first charge of the battery cell. If the temperature variation extends over more than 50% of the first charge, it implies the formation of an unstable SEI layer.

Thus, a negative performance datum is determined if a temperature variation over a predetermined threshold, for example 1° C., is detected to last over 50% of the total span of the first charge of the battery cell. Here, the processor 20 detects if a temperature variation over a predetermined threshold is detected to last over 50% of the total span of the first charge of the battery cell and outputs a negative datum regarding the formation of the SEI layer.

For example, as can be seen on FIG. 3, in which the testing method was applied for a Na-ion Na3V2(PO4)2F3/hard carbon (NVPF/HC) cell with 1M NaPF₆ in DMC electrolyte at a maintained ambient temperature of 25° C., a temperature variation above 1° C. is recorded for a span of more than 50% of the first charge. In particular, the temperature variation remains over 1° C. between 25% and 100% of the first charge, i.e. overt 75% of the total span of the first charge. This indicates the inability of forming a protective SEI, owing to the high solubility of DMC-reduced species such as MeOCOONa and MeONa as can be experimentally observed. This is consistent with the fact that this type kind of electrolyte is identified as a badly performing as compared to other Na-ion Na3V2(PO4)2F3/hard carbon (NVPF/HC) cells.

The datum relating to the formation of the solid electrolyte interface (SEI) layer of the battery cell can also be determined based on data regarding the chemical composition of the electrodes and/or of the electrolyte, for example the amount of guest atoms inserted into the electrode. For instance, the predetermined threshold above which the temperature variation remains for more than 50% of the total span of the first charge of the battery cell to determine a negative formation datum can depend on the chemical composition of the electrodes and/or of the electrolyte.

The testing method also comprises a step of detecting a maximum temperature variation over the first charge of the battery cell 10. A positive formation datum is determined if said maximum temperature variation is detected before a predetermined threshold of the total span of the first charge of the battery cell, for example before 30% of the total span of the first charge of the battery cell.

Indeed, it has been observed that most of the reactions linked to the formation of the SEI layer occur at the beginning of the first charge, for example within the first 30% of the charge, and that temperature variations occurring afterwards are probably due to other electrochemical/chemical reactions. Thus, the presence of the maximum peak of temperature variation at the beginning of the first charge indicates an immediate trigger of the reactions responsible for SEI layer formation, and thus that they will not occur at a later stage, which would be mean that the SEI layer is unstable.

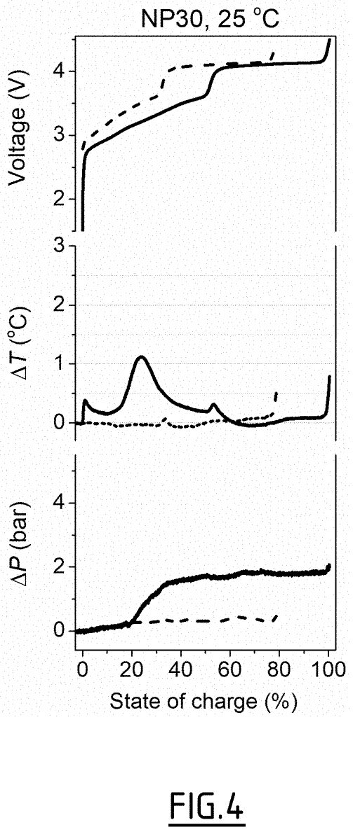

For example, as can be seen on FIG. 4, for the NP30 battery cell at 25° C., the maximum temperature variation is detected before 30% of the first charge of the battery cell. This is consistent with the experimental observation that this battery cell performs well over multiple cycles or charge, i.e. that the SEI layer has formed correctly.

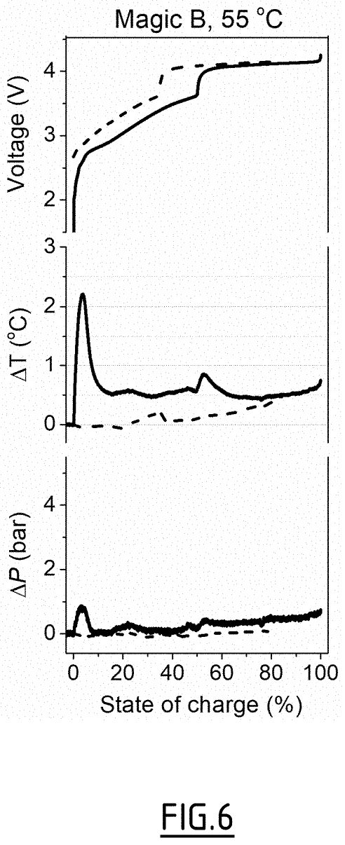

In the same way, as shown on FIG. 6, in which the testing method was applied for a customized electrolyte, named “Magic B” injected into a Na-ion Na3V2(PO4)2F3/hard carbon (NVPF/HC) at 55° C. cell using additives known to improve the formation of the SEI layer, the maximum temperature variation is detected before 30% of the first charge of the battery cell. This is consistent with the experimental observation that this battery cell performs well over multiple cycles or charge, i.e. that the SEI layer has formed correctly, which makes sense as this is the purpose of additives.

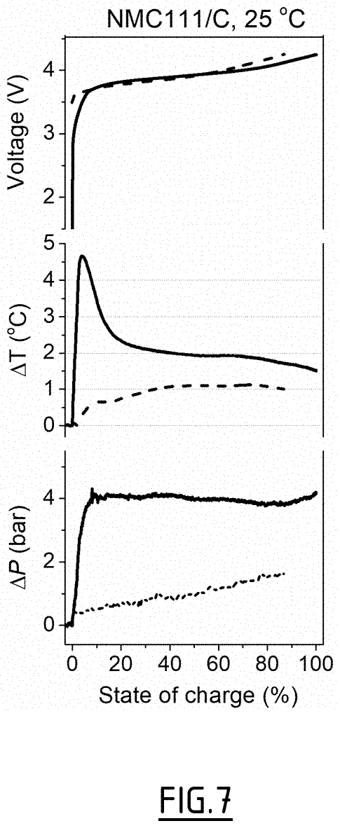

Again, this can be seen on FIG. 7 in which the testing method was applied for a Li-ion /carbon (NMC111/C) cell with a 1M LiPF6 in EC-DMC (LP30) electrolyte over a state of charge of the battery cell, at an ambient temperature of 25° C., where the maximum temperature variation is detected before 30% of the first charge of the battery cell, which is linked to the fact that this battery cell performs correctly.

The method also comprises a step of recording a second set of temperature T data relating to a temperature variation ΔT within the battery cell 10 during a second charge of the battery cell 10, that is subsequent to a first discharge of the battery cell 10 following said first charge of the battery cell 10. Again, this step can be performed by the memory 18, following sensing by the internal temperature sensor 14.

Preferably, the temperatures T are recorded at regular intervals of time over the second charge of the battery cell 10, from 0% of charge to the end of the second charge. It should be noted here that the end of the second charge will be before 100% of the first charge, considering that a battery never fully recharges back to 100% of its capacity. Then, the temperature variation may be plotted against the percentage of the second charge, as shown on FIGS. 3 to 7. On all those Figures, the variation of temperature ΔT recorded over the second charge of the different batteries is shown in a dotted line. Said line ends before the 100%-mark of the first charge, here around 80% of the first charge, which corresponds to the end of the second charge. The full span of the second charge here corresponds to the first 80% of the first charge.

If the record of the second set of temperature data has been made, the positive or negative datum relating to the formation of solid electrolyte interface layer of the battery cell is also determined according to said second set of temperature data, along with the first set of temperature data.

For instance, a positive performance datum is determined if the temperature variation over the whole span of the second charge is lower than a predetermined threshold, preferably sensibly equal to zero. This would correspond to the ideal case where no more electrochemical/chemical reactions linked to the formation of the SEI layer are occurring during the second charge, indicating that it has rapidly stabilized and thus has formed correctly.

Here, the processor 20 detects if no temperature variation over a predetermined threshold is detected over the whole span of the second charge of the battery cell and outputs a positive datum regarding the formation of the SEI layer.

For example, as can be seen on FIG. 4 in which the testing method was applied for a Na-ion Na3V2(PO4)2F3/hard carbon (NVPF/HC) cell with a NP30 electrolyte at a maintained ambient temperature of 25° C., the temperature variation is less than 1° C. for the whole span of the second charge. This is consistent with the experimental observation that this battery cell performs well over multiple cycles or charge, i.e. that the SEI layer has formed correctly.

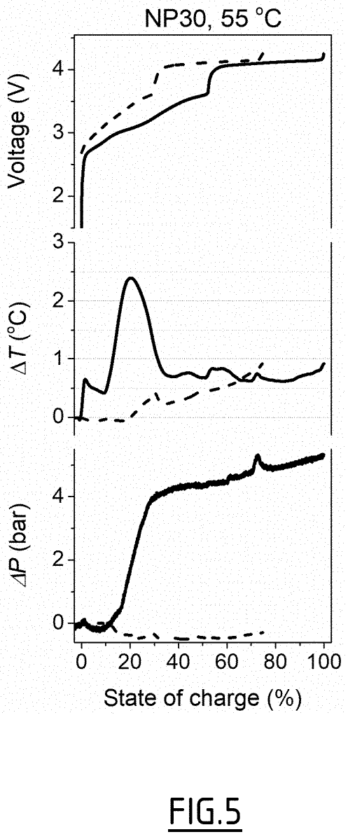

Conversely, as can be seen on FIG. 5, in which the testing method was applied for a Na-ion Na3V2(PO4)2F3/hard carbon (NVPF/HC) cell with a NP30 electrolyte at a maintained ambient temperature of 55° C., the temperature variation is above 0.5° C. from 60% of the second charge and onwards, and even reaches 1° C. This is consistent with the experimental observation that this battery cell, at a high level of ambient temperature of 55° C., unlike at 25° C., does not perform well over multiple cycles or charge, i.e. that the SEI layer has not formed correctly.

As can be seen on FIG. 6 in which the testing method was applied for a customized electrolyte, named “Magic B” injected into a Na-ion Na3V2(PO4)2F3/hard carbon (NVPF/HC) cell using additives known to improve the formation of the SEI layer, even at a high maintained ambient temperature of 55° C., the temperature variation is less than 0.5° C. for the whole span of the second charge. This is consistent with the experimental observation that this battery cell performs well over multiple cycles or charge, i.e. that the SEI layer has formed correctly, which is not a surprise as it is the purpose of using additives.

As mentioned earlier, it has been observed that most of the reactions linked to the formation of the SEI layer occur at the beginning of a charge, for example within the first 30% of a charge and that temperature variations occurring afterwards are probably due to other electrochemical/chemical reactions. Thus, the absence of temperature variations at the beginning of second the charge indicates that the SEI layer has been fully formed during the first charge, i.e. is stable.

Therefore, a positive performance datum is determined if the temperature variation recorded before a predetermined threshold of the second charge, for example before 30% of the second charge, is lower than a predetermined threshold. Here, this temperature variation threshold is for example 0.5° C.

For example, as can be seen on FIGS. 6 and 7 which correspond to batteries which perform well, it is observed that within 30% of the second charge, the temperature variation is under 0.5° C., whereas on FIG. 3, which corresponds to a battery cell which does not perform well, a temperature variation above 0.5° C. is recorded at 20% of the second charge.

Optionally, the testing method also comprises a step of sensing the pressure P within the battery cell, preferably using an FBG sensor 22 as mentioned above.

A first set of pressure data relating to the pressure variation ΔP within the battery cell 10 over time during a first charge of the battery cell 10 is recorded. Preferably, this information is recorded within the memory 18, but it can be recorded a separate data recording device.

Preferably, the pressure P is recorded at regular intervals of time over the first charge of the battery cell, from 0% of charge to 100% of the first charge, and most preferably at the same interval of time as the temperature. It is also desirable that the temperature and pressure are recorded at the same moment.

If a first set of data relating to the pressure variation ΔP over the first charge is recorded, a datum relating to the formation of the solid electrolyte interface (SEI) layer of the battery cell being also determined according to said first set of pressure data.

The testing method according to the disclosure here takes advantage of the information taken from both the temperature and pressure measurement. Indeed, the presence of both sharp temperature ΔT and pressure variations ΔP indicate a trigger of the reactions responsible for a stable SEI layer formation, which emit both heat and gases, within the first charge, and thus that they will not occur at a later stage, which would be that the SEI layer is unstable.

For example, referring back to FIG. 6 in which the testing method was applied for the “Magic B” battery cell including additives, a sharp temperature variation increase is observed before 5% of the first charge, in conjunction with a sharp pressure variation increase before 5% of the first charge. This is consistent with the experimental observation that this battery cell performs well over multiple cycles or charge, i.e. that the SEI layer has formed correctly, which is not a surprise as it is the purpose of using additives.

In the same way, referring back to FIG. 7 in which the testing method is applied to an NMC111/C battery cell, known to perform well, a sharp temperature variation increase is seen at 10% the first charge, in conjunction with a sharp pressure variation increase before 10% of the first charge.

The method also comprises a step of recording a second set of pressure P data relating to a pressure variation ΔP within the battery cell during a second charge of the battery cell, that is subsequent to a first discharge of the battery cell following said first charge of the battery cell. Again, this step can be performed by the memory 18, following sensing by the pressure sensor 22.

Preferably, the pressure is recorded at regular intervals of time over the second charge of the battery cell, from 0% of charge to the end of the second charge. Then, the pressure variation ΔP may be plotted against the percentage of the second charge, as shown on FIGS. 3 to 7. On all of those Figures, the variation of temperature ΔP recorded over the second charge of the different batteries is shown in a dotted line.

If the record of the second set of pressure data has been made, the positive or negative datum relating to the formation of solid electrolyte interface layer of the battery cell 10 is also determined according to said second set of pressure data, along with the first set of pressure data.

Here, the processor 20 detects if no pressure variation ΔP over a predetermined threshold is detected over the whole span of the second charge of the battery cell 10 and outputs a positive datum regarding the formation of the SEI layer. This would correspond to the ideal case where no more chemical reactions linked to the formation of the SEI layer are occurring during the second charge, indicating that it has rapidly stabilized and thus has formed correctly.

For example, as can be seen on FIG. 4 in which the testing method was applied for a Na-ion Na3V2(PO4)2F3/hard carbon (NVPF/HC) cell with a NP30 electrolyte at a maintained ambient temperature of 25° C., the pressure variation is less than 0.5 bar for the whole span of the second charge, in conjunction with the fact that the temperature variation is also almost non-existent in the second charge. This is consistent with the experimental observation that this battery cell performs well over multiple cycles or charge, i.e. that the SEI layer has formed correctly.

In the same way, as can be seen on FIG. 6 in which the testing method was applied for a Na-ion Na3V2(PO4)2F3/hard carbon (NVPF/HC) cell with a customized electrolyte (Magic B) using additives known to improve the formation of the SEI layer, the pressure variation is less than 0.5 bar for the whole span of the second charge, in conjunction with the fact that the temperature variation is also almost non-existent in the second charge. This is consistent with the experimental observation that this battery cell performs well over multiple cycles or charge, i.e. that the SEI layer has formed correctly, which is not a surprise as it is the purpose of using additives.

The disclosure is not limited to the presented embodiments and other embodiments will clearly appear to the person of ordinary skill in the art.

For instance, other temperature sensors may be used, a multiplicity of processors may be used in order to perform the computing required by the testing device, other formats of the battery cells such as pouch, prismatic, and coin cells can be tested, and other chemistries of the battery cells in addition to lithium ion and sodium ion batteries can be tested.

List of references

10: Battery cell

10J: Jelly roll of the battery cell

10H: Hollow part of the battery cell

12: Testing device

14: Internal temperature sensor

16: Electrical power source

18: Memory

20: Processor

22: Internal pressure sensor

T: Internal temperature of the battery cell

P: Internal pressure of the battery cell

1. A testing method for operando testing of a formation of a solid electrolyte interface layer of a battery cell, comprising the following steps:
sensing a temperature within the battery cell;
recording a first set of temperature data related to a temperature variation within the battery cell over a first charge of the battery cell; and
determining a positive or negative datum relating to the formation of solid electrolyte interface layer of the battery cell according to the first set of temperature data.

2. A testing method according to claim 1, wherein the sensing of the temperature is performed using an optical fibre Bragg grating sensor.

3. A testing method according to claim 1, wherein a negative formation datum is determined if a temperature variation above a predetermined threshold is detected to last over 50% of a total span of the first charge of the battery cell.

4. A testing method according to claim 1, also comprising a step of detecting a maximum temperature variation over the first charge of the battery cell, a positive formation datum being determined if said maximum temperature variation is detected before a predetermined threshold of the a total span of the first charge of the battery cell.

5. A testing method according to claim 1, wherein the positive or negative datum relating to the formation of the solid electrolyte interface layer of the battery cell is also determined based on data regarding a chemical composition of the electrodes and/or of the electrolyte.

6. A testing method according to claim 1, also comprising a step of recording a second set of temperature data relating to a temperature variation within the battery cell during a second charge of the battery cell, that is subsequent to a first discharge of the battery cell following said first charge of the battery cell, the positive or negative datum relating to the formation of the solid electrolyte interface layer of the battery cell being also determined according to the second set of temperature data.

7. A testing method according to claim 6, wherein a positive performance datum is determined if the temperature variation over a whole span of the second charge is lower than a predetermined threshold.

8. A testing method according to claim 6, wherein a positive performance datum is determined if the temperature variation recorded before a predetermined threshold of the second charge, is lower than a predetermined threshold.

9. A testing method according to claim 1, wherein it also comprises the steps of:
sensing a pressure within the battery cell;
recording a first set of pressure data relating to a pressure variation within the battery cell over time during the first charge of the battery cell, the positive or negative datum relating to the formation of the solid electrolyte interface layer of the battery cell being also determined according to said first set of pressure data.

10. A testing method according to claim 8, also comprising a step of detecting a maximum pressure variation over the first charge of the battery cell, a positive formation datum being determined if a maximum pressure variation over the first charge is detected before a percentage of the first charge at which a maximum temperature variation was recorded.

11. A testing method according to claim 9, also comprising a step of recording second set of pressure data relating to a pressure variation within the battery cell during a second charge of the battery cell, that is subsequent to a first discharge of the battery cell following said first charge of the battery, the positive or negative datum relating to the formation of the solid electrolyte interface layer of the battery cell being also determined according to the second set of pressure data.

12. A testing method according to claim 11, wherein a positive performance datum is determined if the pressure variation over a whole span of the second charge is lower than a predetermined threshold.

13. A testing device for testing the performance of a battery cell, comprising:
a temperature sensor, configured to be placed inside the battery cell, and able to sense a temperature within the battery cell;
a memory or recording temperatures sensed by the temperature sensor; and
a processor, wherein a memory is able to record temperature data relating to temperature variation within the battery cell sensed by the temperature sensor during a first charge of the battery cell, the processor being able to determine, according to the temperature data recorded by the memory, a positive or negative datum relating to a formation of a solid electrolyte interface layer of the battery cell.

14. The testing device according to claim 13, wherein the temperature sensor is an optical fibre Bragg grating sensor.

15. The testing device according to claim 13, also comprising a pressure sensor, configured to be placed inside the battery cell, able to sense a pressure within the battery cell, wherein the memory is able to record a first set of pressure data relating to pressure variation within the battery cell sensed by the pressure sensor during the first charge of the battery, and the positive or negative datum relating to the formation of the solid electrolyte interface layer of the battery cell is also determined according to the first set of pressure data.

16. The testing device according to claim 15, wherein the pressure sensor is an optical fibre Bragg grating sensor.
